(19) United States
(12) Patent Application Publication
(10) Pub. No.: US 2008/0072998 A1
(43) Pub. Date: Mar. 27, 2008

(54) Adjusting and shifting device for a motor base of a planer

(76) Inventor: Bor-Yann Chuang, Taiping City (TW)

Correspondence Address: BRUCE H. TROXELL, SUITE 1404, 5205 LEESBURG PIKE, FALLS CHURCH, VA, 22041, US

(21) Appl. No.: 11/526,154

(22) Filed: Sep. 25, 2006

(51) Int. Cl. B27C 1/00

(52) U.S. Cl. 144/114.1

(57) ABSTRACT

An adjusting and shifting device for a motor base of a planer includes a shifting device fixed on an adjust base of a planer and consisting of a fix base and a rotary base. The fix base is fixed on the adjust base, and a gear unit pivotally connected in the adjust base and pivotally connected to the bottom of the rotary base via an interactive rod. The rotary base is provided with a shaft at a front side of the bottom. The interactive rod moves the adjust base to swing with the shaft as a pivot, so the motor pivotally connected on the rotary base may swing for a preset angle to move farther from the adjust base.

### BACKGROUND OF THE INNENTION

1. Field of the Invention

This invention relates to an adjusting and shifting device for a motor base of a planer, particularly to one provided with a shifting device on the adjust base for enhancing efficiency of changing a plane.

2. Description of the Prior Art

A conventional planer 1 shown in FIG. 1 includes a base 10, four guide rods 11 fixed around the base 10, an adjust base 20 threadably provided on the guide rods 11.

The adjust base 20 can be moved back and forth for adjusting the distance between itself and the base 10. At the same time, a plane shaft 21 is pivotally connected to the adjust base 20, rotated by a motor 22 fixed on the adjust base 20 so as to carry out planning. Further, a dust collecting cover 23 is covered above the plane shaft 21 for preventing planed wastes from flying around.

However, the conventional planer 1 has the motor 22 directly located just above the plane shaft 21 for transmitting convenience. But in replacing the plane fixed on the plane shaft 21 with a new one in case of the plane gotten dull, the dust collecting cover 23 has to be taken off first, and then the plane on the plane shaft 21 can be taken off. Moreover, the motor 22 is located between the adjusting base 20 and the dust collecting cover 23, so the handling space for taking off the plane shaft 21 becomes very narrow so that the plane of the plane shaft 21 is quite difficult to be taken off, hampered by the motor 22.

### SUMMARY OF THE INVENTION

This inventin has been devised to offer an adjusting and shifting device for a motor base of a planer for facilitating the plane to be easily taken off.

The feature of the invention is a shifting device fixed on the adjust base of a planer, and the shifting device is composed of a fix base and a rotary base. The fix base is fixed on the adjust base, provided with a gear unit pivotally connected to the bottom of the rotary base. The rotary base has a shaft at the front end of the bottom, and the shaft is pivotally connected to the fix base, so the rotary base can be moved by an interactive rod of the rotary base to swing for a preset angle with the shaft as a pivot. Then the motor fixed pivotally on the rotary base is also swung for the same angle, then moves farther away from the adjust base. Therefore, a hollow space may be increased on the adjust base so that the plane on the plane shaft may more easily be taken off for repair or replacement.

### BRIEF DESCRIPTION OF DRAWINGS

This invention will be better understood by referring to the accompanying drawings, wherein:

FIG. 1 is a perspective view of a conventional planer;

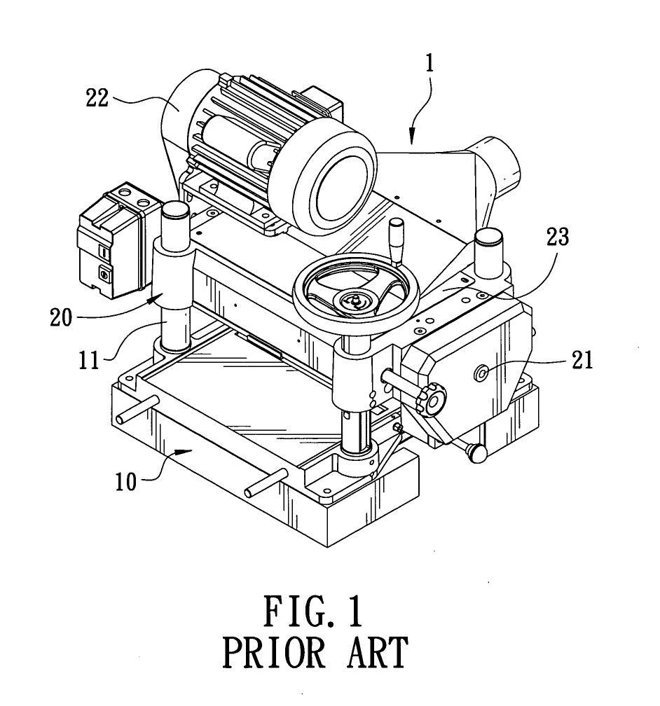

FIG. 2 is a perspective view of a preferred embodiment of an adjusting and shafting device for a motor base of a planer in the present invention;

FIG. 3 is a perspective view of the preferred embodiment of a part adjusting and shifting device in the present invention

FIG. 4 is an exploded perspective view of the preferred embodiment of an adjusting and shifting device in the present invention;

FIG. 5 is a side view of the preferred embodiment of an adjusting and shifting device with a motor not taken off in the present invention;

FIG. 6 is a side view of the preferred embodiment of an adjusting and shifting device with the motor taken off in the present invention;

FIG. 7 is another side view of the preferred embodiment of an adjusting and shifting device with a transmitting belt being taken away in the present invention; and,

FIG. 8 is a view of the preferred embodiment of an adjusting and shifting device with a rotary base being moved in the present invention.

### DETAILED DESCRIPTION OF THE PREFERRED EMBODIMENT

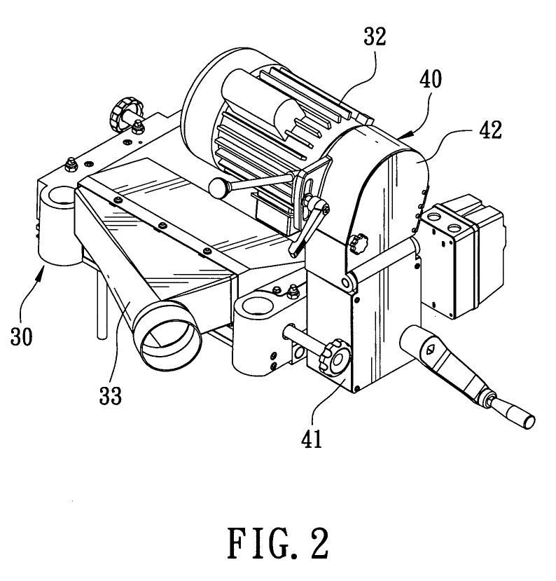

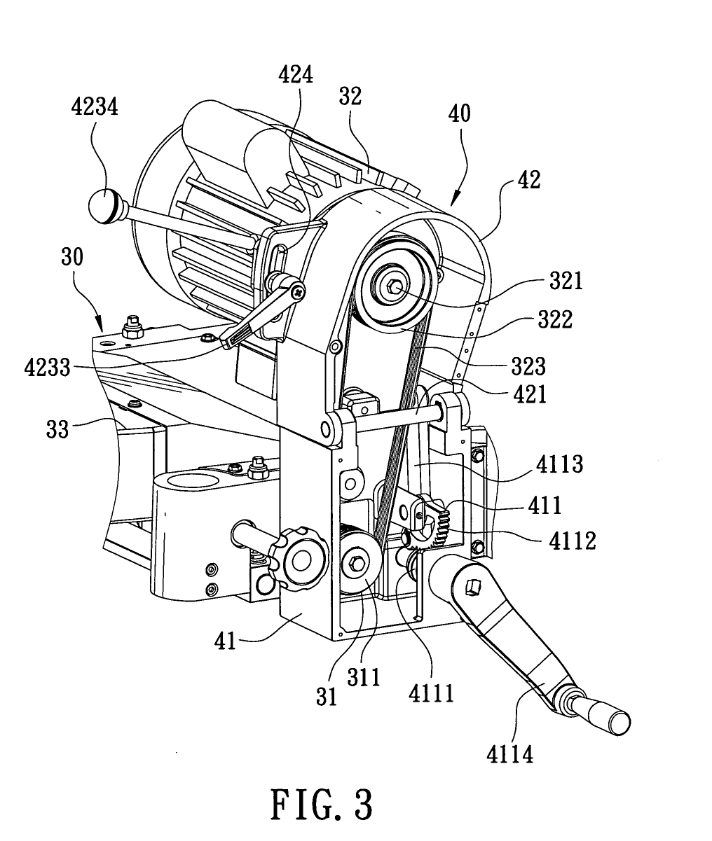

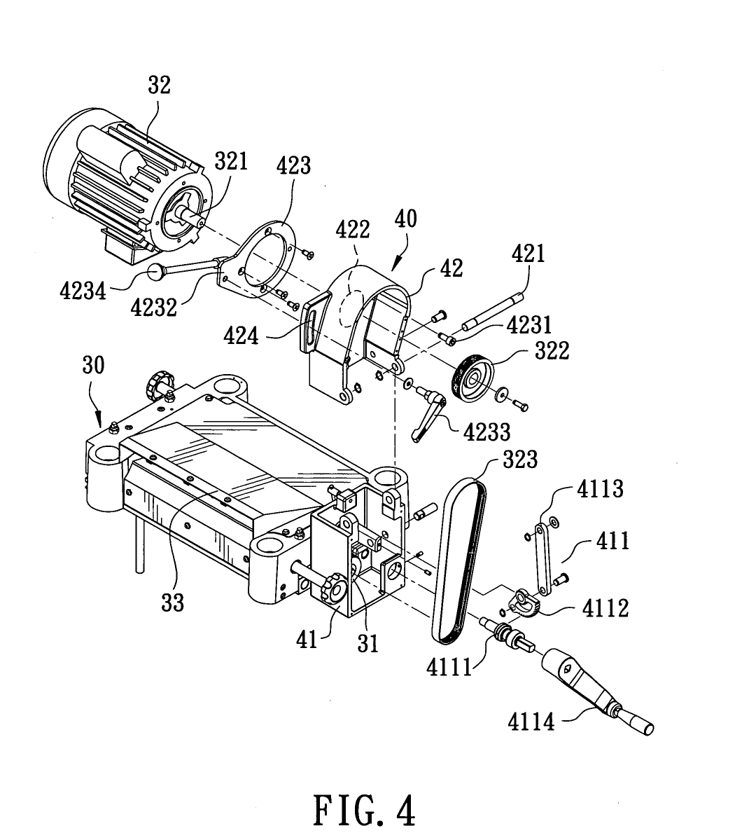

A preferred embodiment of an adjusting and shifting device for a motor base of a planer in the present invention, as shown in FIGS. 2, 3 and 4, includes a shifting device 40, and the planer has an adjusting base 30, a plane shaft 31 pivotally connected in the adjust base 30, a first belt wheel 311 fixed at an outer side of the adjust base 30, a motor 32 fixed above the adjust base 30 and having a spindle 321, a second belt wheel 322 fixed on the spindle 321, a transmitting belt 323 mounted around the first and the second belt wheel 321 and 322. Then the motor 32 rotates to turn the plane shaft 21, which then carries out planning by a plane fixed thereon. Further a dust collecting cover unit 33 is covered over the adjust base 30, and the motor 32 is pivotally connected to the adjust base 30 via the shifting device 40.

The shift device 40 is composed of a fix base 41 and a rotary base 42.

The fix base 41 is fixed at one side where the belt wheel 311 is located, having a gear unit 411 pivotally connected in its interior and consisting of a worm 41111, a fan-shaped gear 4112 and a interactive rod 4113. The worm 4111 is engaged with the fan-shaped gear 4112, and the interactive rod 4113 has one end pivotally connected to one end of the fan-shaped gear 4112 and the other end pivotally fixed in a bottom of the rotary base 42. Further, there is a rotary handle 4114 fixed with an outer end of the worm 4111 at the outer side of the fix base 41.

The rotary base 42 has a shaft 421 pivotally connected to the fix base 41, forming a rotary distance between itself and the interactive rod 4113, so that the rotary base 42 can be pushed by the interactive rod 4113 to swing for a preset angle with the shaft 421 as a pivot. Further the rotary base 42 is provided with a slide hole 422 in a front side for the spindle 321 of the motor 32 to fit therethrough. Further rotary base 42 has a direction changing disc 423 fixed between the front end of the motor 32 and the rotary base 42 and having one side pivotally connected to the rotary base 42 by a shaft 4231 so that the rotary base 423 can turn the motor 32 for a preset angle. Then the spindle 321 can rotate for the preset angle accordingly in the slide hole 422. In addition, the rotary disc 423 is provided with a guide member 4232 protruding from one side, and the rotary base 42 is provided with a guide slot 424 in corresponding to the guide member 4232, which is threadably combined with a fix rod 4233, which also extends through the guide slot 424. Further, the guide member 4232 is fixed with an inner end of a pull rod 4234 at one side, enabling the rotary base 423 to be turned by the pull rod 4234.

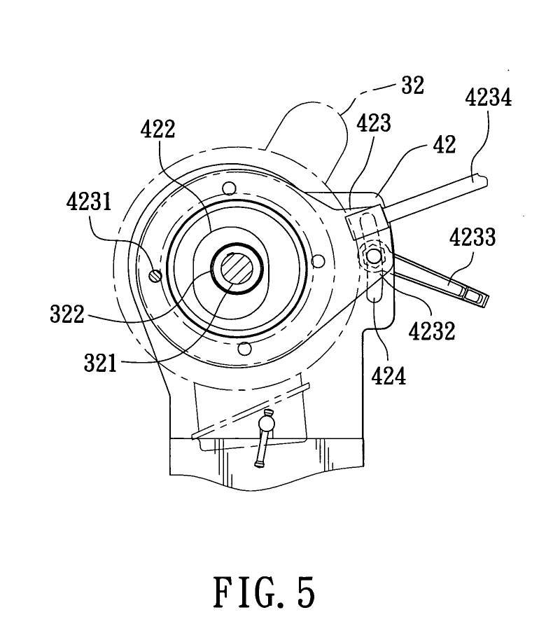

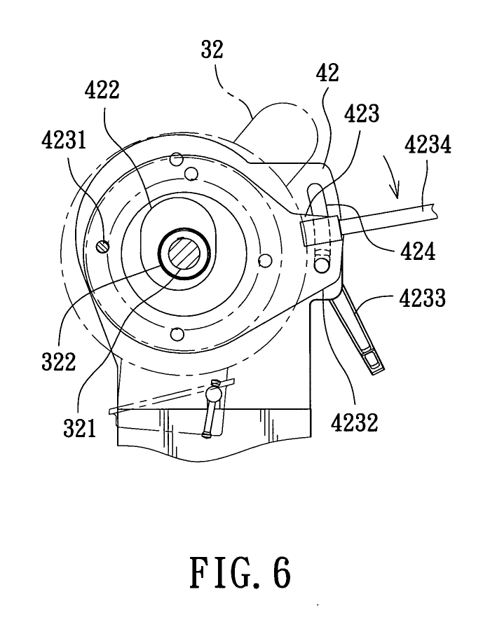

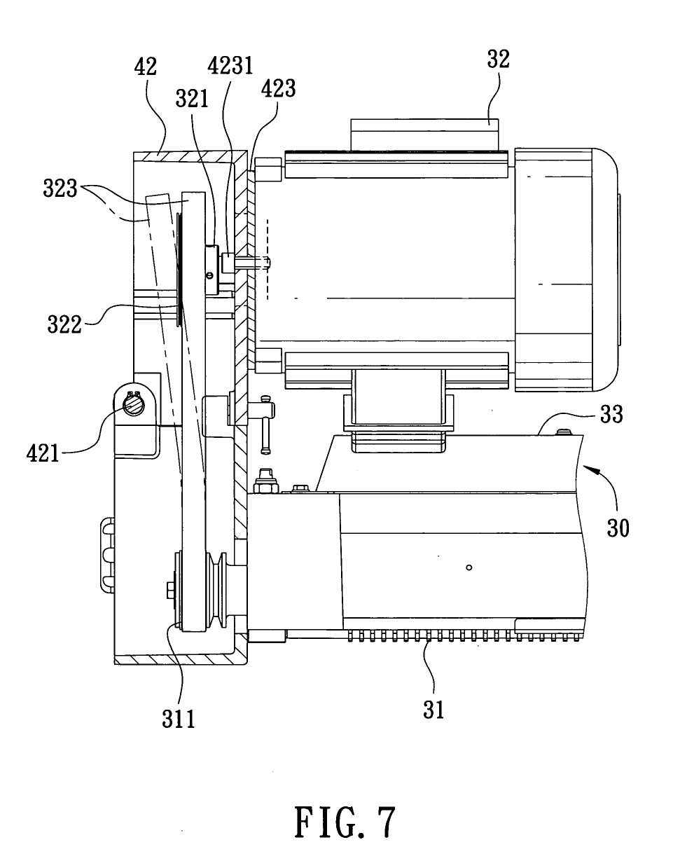

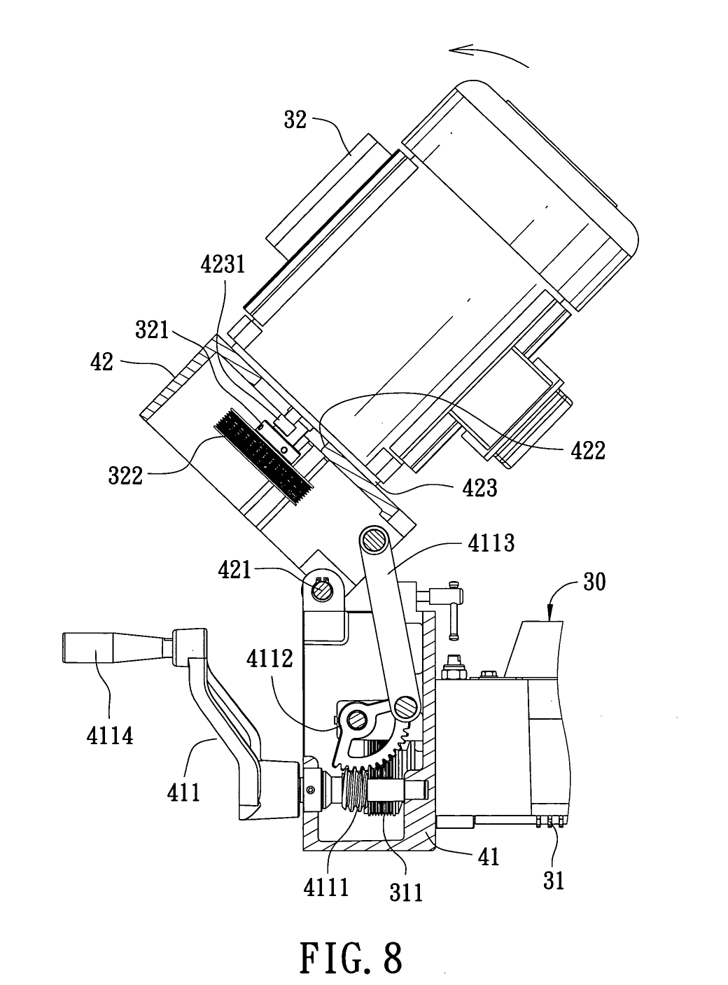

Next, in using, as shown in FIGS. 5, 6 and 7, after the plane of the plane shaft 31 is used for a period of time, and it has to be replaced with a new one owing to wear and tear, firstly loosen the fix rod 4233 to move freely in the slot 424, and at the same time turn the rotary disc 423 by handling the pull rod 4234 so the motor 32 can swing downward for the preset angle with the shaft 4231 as a pivot. Then the belt wheel 322 of the motor 32 moves down, slackening the transmitting belt 323, which is then possible to be taken off the belt wheel 322. After that, as shown in FIG. 8, grip and rotate the rotary handle 4114, forcing the worm 4111 rotate, so the fan-shaped gear 4112 may be turned by the worm 4111 to lift up the interactive rod 4113, which then moves the rotary base 42 to swing counterclockwise for the preset angle with the shaft 421 as a pivot. Then the motor 32 is swung together with the rotary case 42, moved farther from the adjust base 30, enabling the dust collecting cover 33 to be easily taken off, and at the same time the plane of the plane shaft 31 is also easily be taken off to be repaired or replaced with a new one, not hampered by the motor 32.

After finishing repair or replacement of the plane, the dust collecting cover 33 is to be closed back on the ad just base 30, and the gear unit 411 is to be rotated reversely, letting the interactive rod 4113 to lower down and the rotary base 42 to move nearer to the adjust base 30. Then the transmitting belt 323 is mounted back on the belt wheel 322 of the motor 32, and the rotary base 42 is rotated to tighten the transmitting belt 323, enabling the planer to operate again.

The invention has the following advantages as can be understood from the foresaid description.
1. The motor can be moved farther from the adjust base by moving the rotary base, so the plane on the plane shaft can be taken off or put back easily for repair or replacement, not hampered by the motor, enhancing efficiency of using the planer and market competitiveness of the planer.

While the preferred embodiment of the invention has been described above, it will be recognized and understood that various modifications may be made therein and the appended claims are intended to cover all such modifications that may fall within the spirit and scope of the invention.

What is claimed is:

1. An adjusting and shifting device for a motor base of a planer, said planer having an adjust base, a plane shaft pivotally connected to said adjust base, and a motor pivotally connected on said adjust base and having a spindle for rotate said planer shaft for carrying out planning, said device comprising:
A shifting device fixed on said adjust base at a preset location, said shifting device consisting of a fix base and a rotary base;
Said fix base fixed on said adjust base, a gear unit pivotally connected in an interior of said fix base, said gear unit pivotally fixed at a rear side of a bottom of said rotary base by means of an interactive rod;
Said rotary base having a shaft at a front side of its bottom, said shaft pivotally connected to said fix base, said rotary base able to be swung by said interactive rod for a preset angle with said shaft as a pivot, said motor pivotally connected to said rotary base and swung for the same angle together with said rotary base synchronously.

2. The adjusting and shifting device for a motor base of a planer as claimed in claim 1, wherein said gear unit is composed of a worm, a fan-shaped gear and said interactive rod, said worm engaging with said fan-shaped gear, said interactive rod having one end pivotally connected to an end of said fan-shaped gear and the other end pivotally fixed with a rear end of a bottom of said rotary base, a rotary distance formed between said interactive rod and said shaft, said gear unit further provided with a rotary handle pivotally connected with said worm at an outer side of said fix base.

3. The adjusting and shifting device as claimed in claim 1, wherein said rotary base is provided with a slide hole in a front side, said spindle of said motor pivotally connected in said slide hole, a direction changing disc fixed on said motor and having one side pivotally connected to said rotary base with a rotary shaft, said rotary base able to be swung with said rotary shaft as a pivot so that said motor may be swung for the same angle as said rotary base, said spindle of said motor also swinging for the same angle in said slide hole, said direction changing disc provided with a guide member protruding from one side, a guide rod fixed on one side of said guide member, said rotary base provided with a guide slot corresponding to said guide member, a fix rod fitting through said slot and having an inner end threadably combined with said guide member.
